(19) United States
(12) Patent Application Publication
(10) Pub. No.: US 2011/0188735 A1
(43) Pub. Date: Aug. 4, 2011

(54) METHOD AND DEVICE FOR DEFECT INSPECTION

(76) Inventors: Naoki Hosoya, Tokyo (JP); Toshifumi Honda, Yokohama (JP); Takashi Hiroi, Yokohama (JP)

(21) Appl. No.: 13/057,782

(22) PCT Filed: Jun. 5, 2009
(86) PCT No.: PCT/JP2009/002549

§ 371 Date: Apr. 20, 2011

(30) Foreign Application Priority Data
Aug. 28, 2008 (JP) 2008-219732

(51) Int. Cl. G06K 9/00

(52) U.S. Cl. 382/149

(57) ABSTRACT

Provided are a method and a device for defect inspection, wherein, in a state where a few DOIs exist in a large number of nuisances, a classification performance can be improved by a few appropriate defect instructions and a high classification performance is ensured while mitigating the burden of user's defect instructions. The method and device for defect inspection is characterized by repeating extraction of one or more defects from a plurality of defects detected by imaging a sample, instruction of a classification class of the extracted defects, and calculation of a classification criterion and a classification performance from the image information and classification class of the defects, and determining, based on the finally obtained classification criterion, the classification class of the unknown defects. This makes it possible to improve a classification performance by a few appropriate defect instructions and ensure a high classification performance while mitigating the burden of user's defect instructions.

### TECHNICAL FIELD

The invention relates to a technology for inspecting a semiconductor wafer, and more particularly, to an effective technology applied to the method for setting a defect classification criterion of an inspection device.

### BACKGROUND ART

Miniaturization of the semiconductor has been markedly advanced accompanied with the recent trend of compact and highly sophisticated electronic products, resulting in new products which hit the market in succession. Meanwhile in the semiconductor manufacturing step, the in-line defect inspection of the semiconductor wafer is conducted. Accompanied with miniaturization of the semiconductor, the defect as the cause of the device failure, that is, the defect of interest (DOI) has also been miniaturized. The highly sensitive defect inspection which is capable of coping with such miniaturization has been demanded. Several tens of thousands of defects of disinterest (nuisances) on the wafer such as negligible irregular surface are detected, resulting in the state where a few DOIs exist in a large number of defects which include nuisances.

It is therefore important to ensure detection only of the DOIs of the new device. The method for automatically classifying the defect has been proposed as Auto Defect Classification (ADC) conducted by analyzing the image obtained from the inspection which has been conducted using the appearance tester. Alternatively, a method has been proposed for automatically classifying further detailed images of the defect, which have been detected again after conducting the inspection using the appearance inspection device.

Various methods have been proposed for conducting the ADC, which include a rule type process for classifying the defect features including plural image featured values such as brightness and defect shape extracted from the image into the defect class based on the predetermined rule, an instruction type for setting plural scalar values each as a group of the respective items of the defect features to a multidimensional vector to automatically generate the criterion for classifying the detects based on distribution of the defect class in the multidimensional space formed by the multidimensional vector, and further a combination type formed by combining the rule type and the instruction type.

In order to automatically classify the defect by conducting the ADC, the defect classification criterion is required to be set before automatic classification based on the defect sample with a known classification class.

In the case of using the rule type, generally, it is necessary to set determination threshold values corresponding to some items of the defect feature. In the case of using the instruction type, it is necessary to obtain distribution of the defect class in the multidimensional space. In the state where a large number of defects are detected by the inspection device, the method which allows appropriate and easy setting of the defect classification criterion is indispensable.

As for setting of the defect classification criterion, Patent Document 1 discloses the image recognition device for recognizing the classification class of the online image by comparing the sample image data with normal image data to obtain the appropriate defect classification pattern to be instructed, and further obtaining the featured value with respect to the defects. Patent. Document 2 discloses the inspection device structured to evaluate the classification criterion when right or wrong of classification of the defect group with a known classification class based on the preliminarily obtained classification criterion to the known value is relatively low. Patent Document 3 discloses the automatic classification device provided with the function for updating the instruction data used for automatic classification based on the defect image information on the basis of the feature of the defect image.

### Citation List

### Patent Literature

Patent Literature 1: JP-A No. 2005-293264
Patent Literature 2: JP-A No. 2004-295879
Patent Literature 3: JP-A No. 2001-256480

### SUMMARY OF INVENTION

### Problem to be Solved by the Invention

With the method disclosed in Patent Document 1, the user instructs the instruction data found from the defect image data. The user also instructs the data required to be corrected among the classified defect image data. In any of the cases, it is up to the user to select the defect image.

The method disclosed in Patent Document 2 discloses the classification criterion which becomes more stable as the increase in the instruction data. However, the classification criterion which may be derived from less of instruction data is not disclosed.

With the method disclosed in Patent Document 3, the user instructs the defect class of each of the collected defect images. In this case, at least one of the existing instruction data and the newly collected defect image data may be used for generating the new instruction data through generally employed method for generating instruction data.

In order to ensure detection of the DOI, it is necessary to make sure to instruct the DOI. However, appropriate instruction is not easy in the state where a few DOIs exist in a large number of nuisances. For this, the user may be forced to bear the burden of instructing the defect while confirming several tens of defects one by one. Otherwise, as a result of instructing only some of the defects, the classification criterion cannot be optimized, resulting in missing of the DOI or misinformation where the nuisance is incorrectly classified as DOI.

It is a first object of the present invention to provide a method and a device for inspection capable of improving the classification performance by a few appropriate defect instructions even in the state where a few DOIs exist in a large number of nuisances during the defect inspection.

It is a second object of the present invention to provide a method and a device for inspection capable of ensuring high classification performance while mitigating the burden of the user's defect instructions even in the state where a few DOIs exist in a large number of nuisances during the defect inspection.

### Means for Solving the Problem

For the purpose of achieving the aforementioned objects, the present invention provides an inspection method including: a defect extraction step of extracting one or more defects from plural defects detected by imaging a sample; a defect image display step of displaying an image of the extracted defect; a defect classification class input step of inputting a classification class of the displayed defect; a classification criterion calculation step of calculating a classification criterion from image information and classification class of the defects which have been extracted; a classification performance determination step of determining a performance of the defect classification based on the classification criterion; and an inspection step of inspecting unknown defects based on the classification criterion calculated in the classification criterion calculation step.

For the purpose of achieving the aforementioned objects, the present invention provides an inspection device including: defect extraction means for extracting one or more defects from plural defects detected by imaging a sample; defect image display means for displaying an image of the extracted defect; defect classification class input means for inputting a classification class of the displayed defect; classification criterion calculation means for calculating a classification criterion from image information and classification class of the defects which have been extracted; classification performance determination means for determining a performance of the defect classification based on the classification criterion; and inspection means for inspecting unknown defects based on the classification criterion calculated by the classification criterion calculation means.

### Effect of Invention

The present invention provides the method and device for inspection capable of improving the classification performance by a few appropriate defect instructions even in the state where a few DOIs exist in a large number of nuisances in the defect inspection.

Furthermore, the preset invention provides the method and device for inspection capable of ensuring high classification performance while mitigating the burden of the user's defect instructions even in the state where a few DOIs exist in a large number of nuisances in the defect inspection.

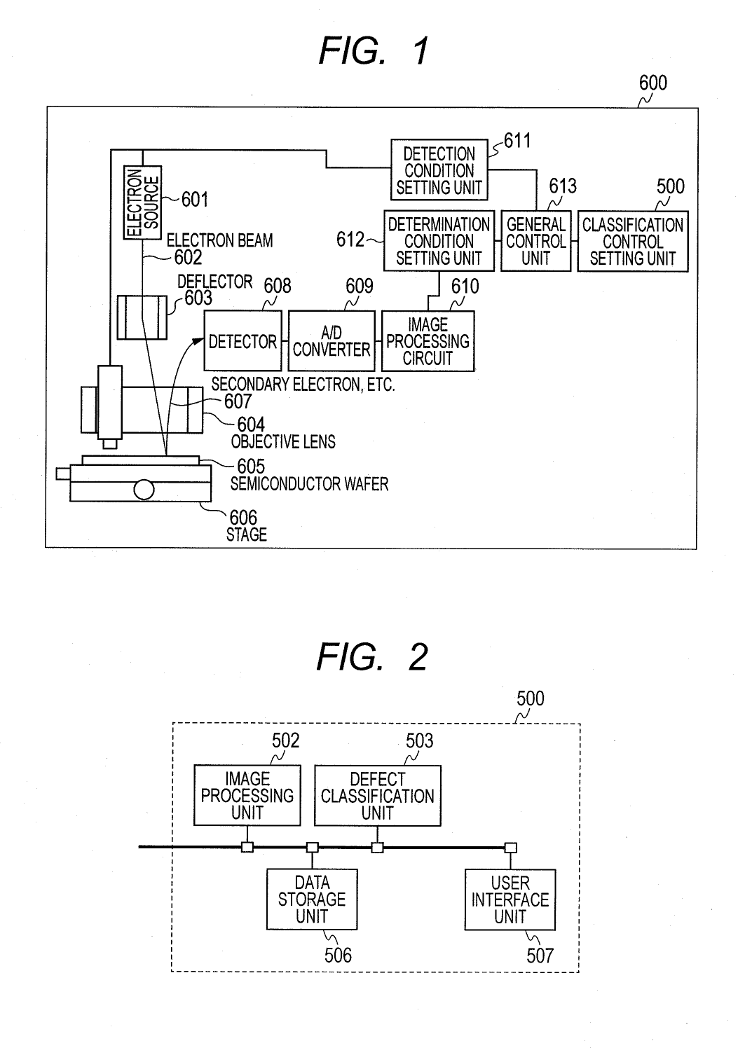

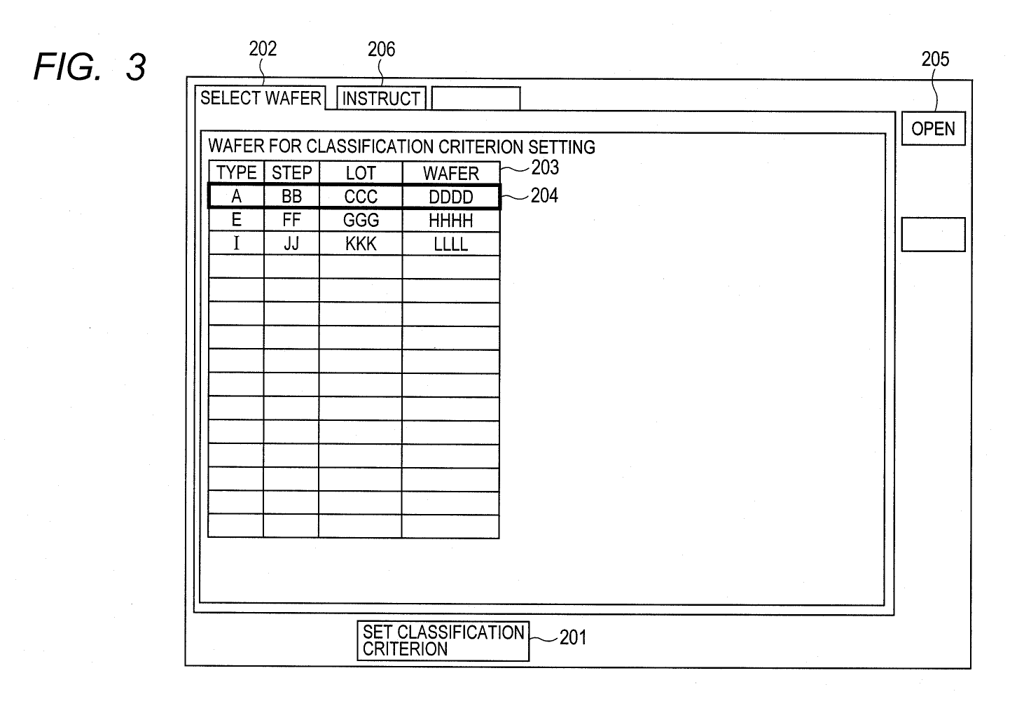

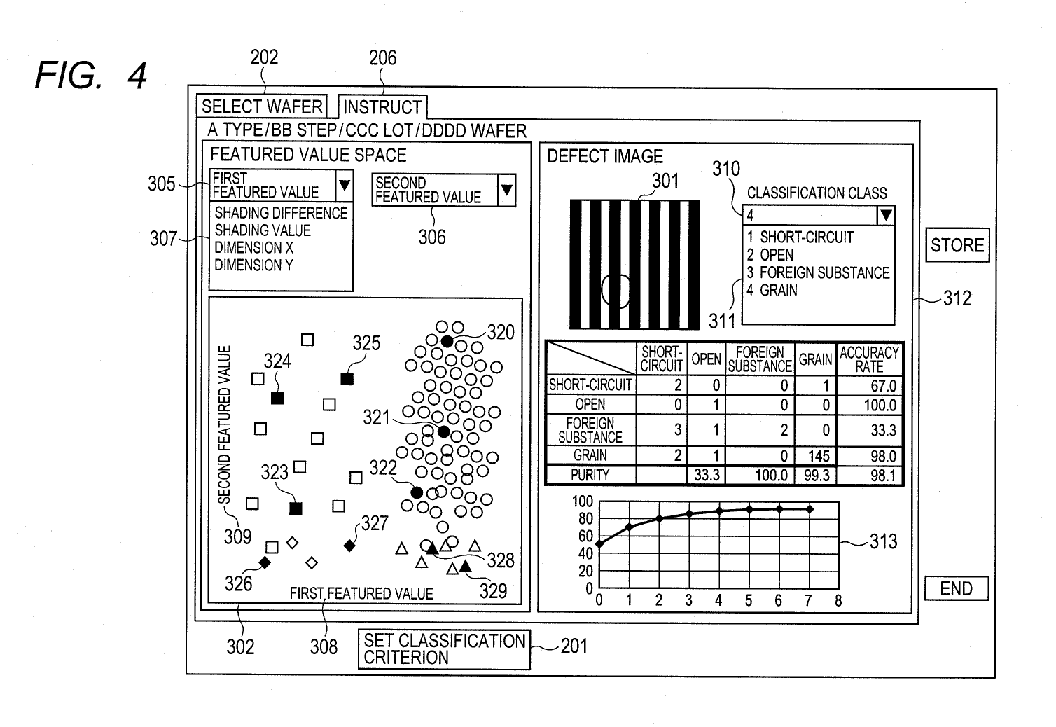

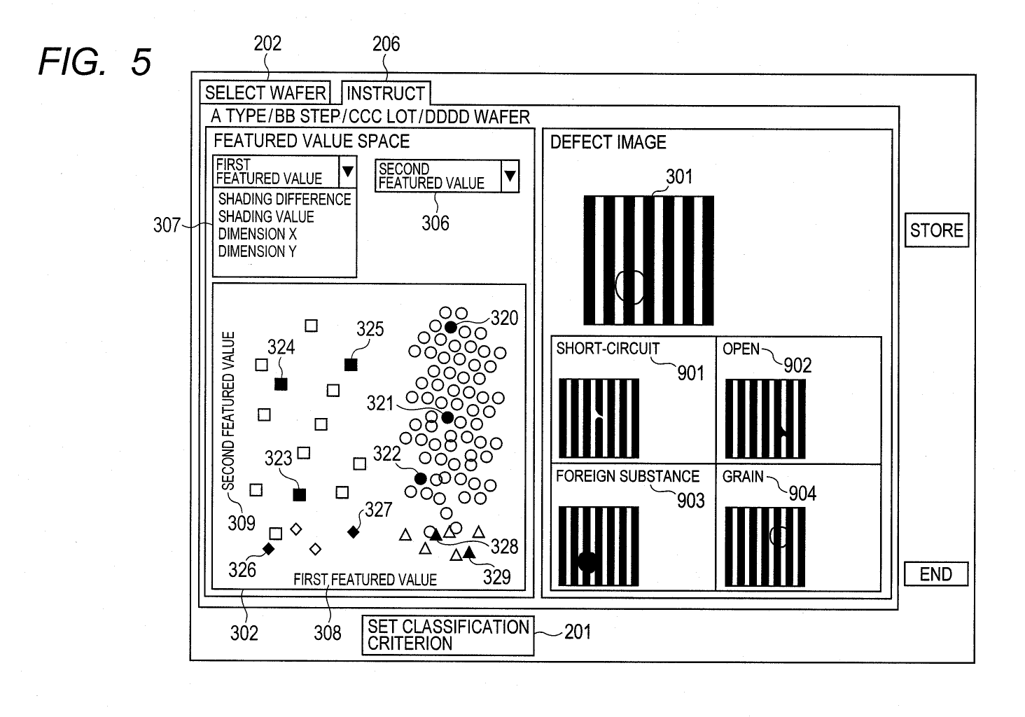

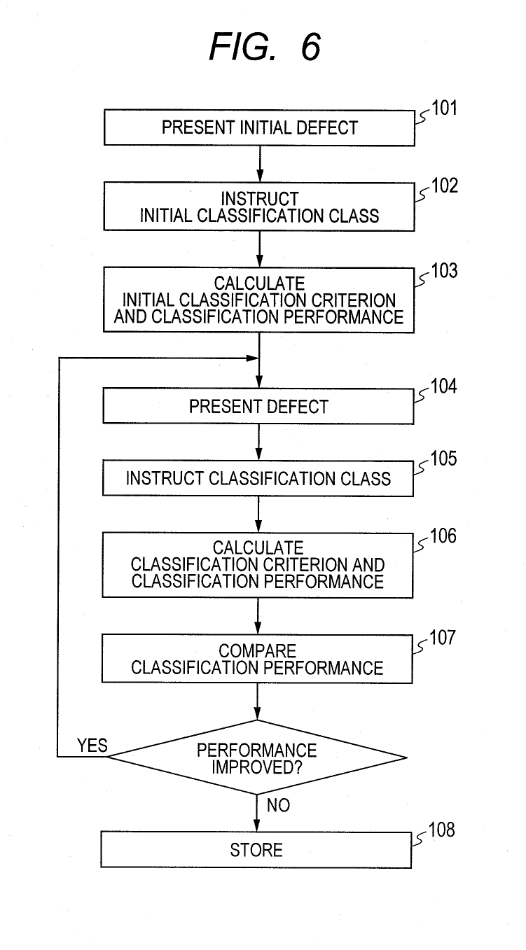

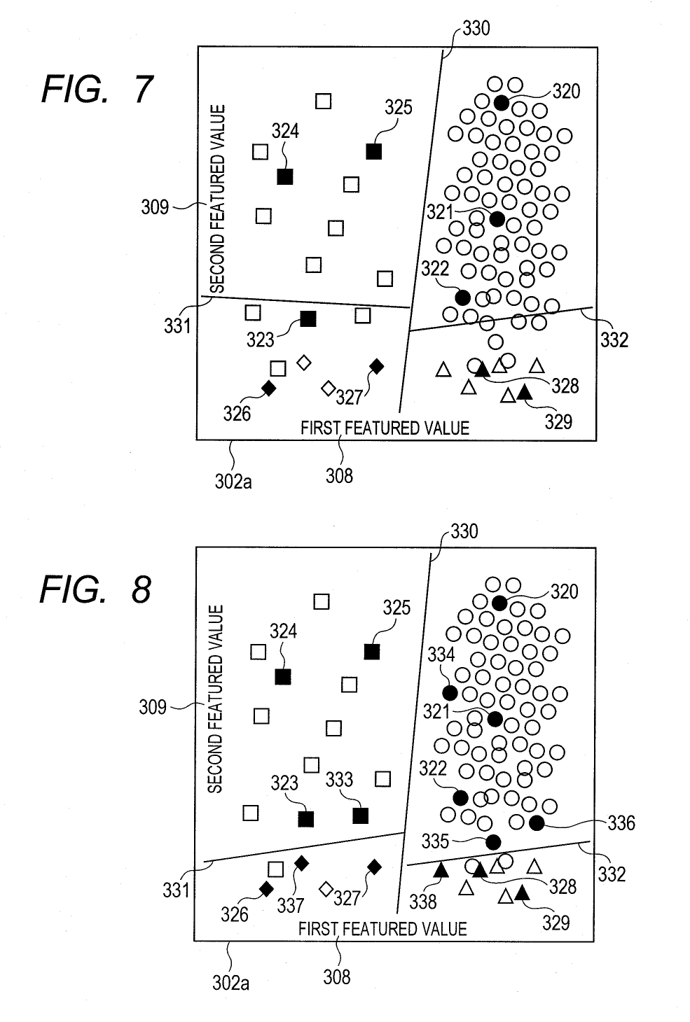

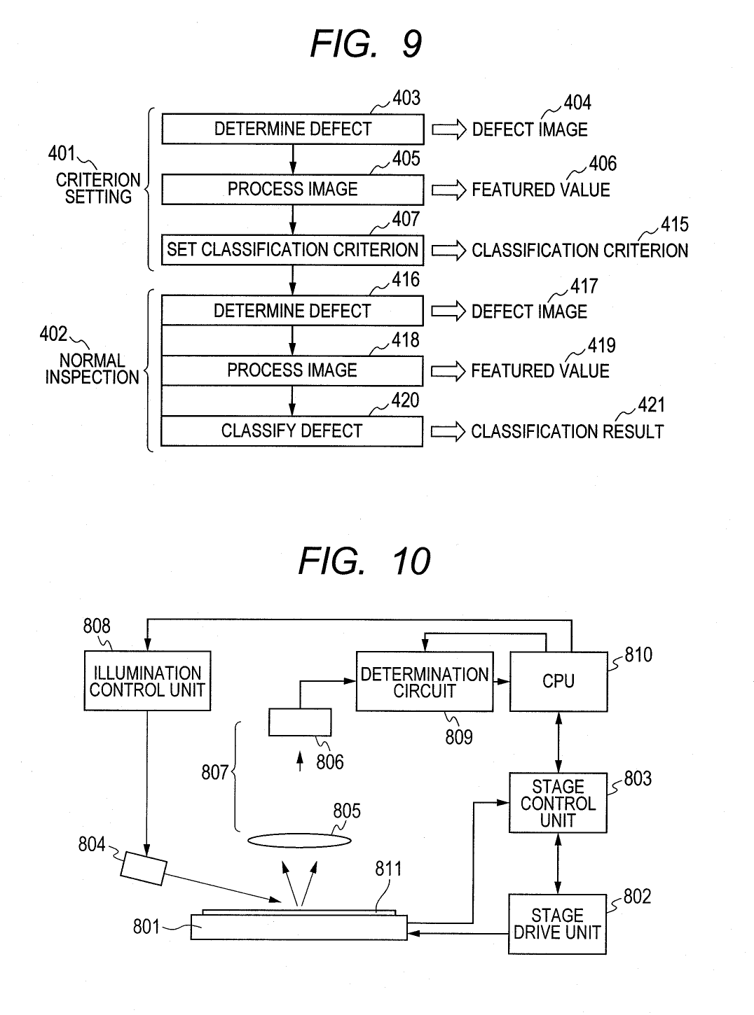

### BRIEF DESCRIPTION OF THE DRAWINGS

[FIG. 1] A view showing a structure of an SEM type semiconductor inspection device according to an embodiment of the present invention.

[FIG. 2] A view showing a structure of a defect processing unit according to the embodiment of the present invention.

[FIG. 3] A view showing an example of a wafer selection screen according to the embodiment of the present invention.

[FIG. 4] A view representing an example of an instruction screen according to the embodiment of the present invention.

[FIG. 5] A view representing another example of the instruction screen according to the embodiment of the present invention.

[FIG. 6] A view representing an example of a sequence for setting a classification criterion according to the embodiment of the present invention.

[FIG. 7] A view showing a featured value space at an initial cycle.

[FIG. 8] A view showing the featured value space at a second cycle.

[FIG. 9] A view showing a procedure of the inspection method according to the embodiment of the present invention.

[FIG. 10] A view showing a structure of an optical inspection device according to another embodiment of the present invention.

### MODE FOR CARRYING OUT THE INVENTION

A first embodiment of the present invention will be described referring to the drawings.

FIG. 1 shows an exemplary structure of an SEM type semiconductor wafer inspection device 600 according to the embodiment. FIG. 2 shows a structure of a classification condition setting unit 500 as a part of the aforementioned structure in detail. The inspection device includes an electron source 601 which generates an electron beam 602, a deflector 603 which defects the electron beam 602 from the electron source 601 toward an X-direction, an objective lens 604 which focuses the electron beam 602 to a semiconductor wafer 605, a stage 606 which moves the semiconductor wafer 605 toward a Y-direction simultaneously with deflection of the electron beam 602, a detector 608 which detects a secondary electron 607, etc. from the semiconductor wafer 605, an A/D converter 609 which A/D converts the detection signal into a digital image, an image processing circuit 610 formed of plural processors and an electronic circuit such as FPGA, which compares the detected digital image with a digital image at a location expected to be identical, and determines the location with difference as a possible defect, a detection condition setting unit 611 which sets a condition of a portion relevant to formation of images of the electron source 601, the deflector 602, the objective lens 604, the detector 608, the stage 606 and the like, a determination condition setting unit 612 which sets a condition for determining a defect of the image processing circuit, general control unit 613 which executes a general control operation, and the classification condition setting unit 500 which sets the condition for determining the defect.

The determination condition setting unit 612 stores conditions based on which a determination is made with respect to the defect of the semiconductor wafer. The image processing circuit 610 processes the image, and makes the defect determination based on the condition so as to extract the defect image. The defect image is transmitted to the classification condition setting unit 500 via the general control unit 613. The classification condition setting unit 500 includes an image processing unit 502 which processes the image of the defect to extract the featured value, a defect classification unit 503 which extracts the defect by calculating the featured value, creates the classification criterion, and calculates the classification performance, a data storage unit 506 which stores the classification criterion, the defect image, the defect featured value and the defect classification, and a user interface unit 507 which displays the defect image and the defect featured value on the screen, and allows the user to input the defect classification instruction. They are connected with one another so that data is transmitted and received as necessary.

The aforementioned means will be described in accordance with the embodiment of the present invention. First of all, the subject wafer is selected, and an instruction is conducted.

FIG. 3 shows an example of a wafer selection screen as one of screens supplied by the user interface according to the embodiment. A classification criterion set button 201 on the screen is clicked, and a wafer select tab 202 is clicked to display the screen. A list 203 of the semiconductor wafers selectable as being subjected to setting of the classification criterion is displayed on the screen. In the list 203, the wafer information is displayed on a single line. The displayed wafer information includes such items as type, step, lot name, wafer name and the like. The displayed wafer is inspected by the inspection device preliminarily. Then the image at the location determined as the defect through the defect determination is extracted. The featured value of each of the defect images is calculated through the image processing. The featured value is input into the user interface together with the aforementioned wafer information. The line of the wafer required to present the inspection condition, for example, the line defined as A type BB step CCC lot DDDD wafer 204 is clicked, and an open button 205 is clicked. Then the wafer subjected to setting of the classification criterion is specified.

Clicking an instruction tab 206 allows transition to the instruction screen. FIG. 4 shows an example of the instruction screen. The instruction screen according to the embodiment includes a first featured value designation button 305 and a second featured value designation button 306 so that two featured values are designated. Upon selection of those buttons, the featured value is indicated on a featured value display 307 so that the featured value is designated. Upon designation of the featured value, a featured value space map 302 showing the respective featured values is displayed below the display section. Based on the values defined by Y-axis and X-axis, the user obtains the featured value of the defect. The featured value space map 302 displays codes, for example, ◯ (grain defect), Δ (short-circuit defect), [symbol] (foreign substance defect), and ⋄ (open defect) each indicating the defect type. Classification criteria 330 to 332 (see FIG. 7) are displayed on the featured value space map 302 by executing means to be described layer.

An image 301 of the automatically extracted defect is displayed at the upper right section on the, screen. A classification class is displayed at the right side of the image. When a classification class input column 310 is designated, the subject defect is displayed. Upon selection of the defect by the user, the defect type may be designated.

An accuracy rate table 312 indicating right or wrong is displayed at the lower section, the X-axis of which indicates the defect type determined by the aforementioned means and the Y-axis of which indicates the defect type instructed by the user using the classification class input column 310. Referring to the short-circuit column, the means indicates that the user has instructed three short-circuit defects. With the means, the grain defect is determined one time. As a result, the accuracy rate becomes ⅔=67%. A graph 313 representing transition of classification performance is displayed at the lower right side.

FIG. 5 shows another embodiment of the screen on which the defect type is instructed. Windows corresponding to the classification classes are displayed at the lower right section on the instruction screen. The screen displays a short-circuit defect window 901, an open defect window 902, a foreign substance defect window 903, and a grain defect window 904. The number of the windows may be arbitrarily set without being limited to four. The instruction is performed by the user to move the displayed image of the defect to the window corresponding to the classification class of the defect.

FIG. 6 represents an exemplary embodiment of a sequence for setting the classification criterion and classification performance which will be processed by the classification criterion setting unit 500. Each content of the means will be described in detail referring to the instruction screen.

### (1) Initial Defect Presenting Means 101:

It is assumed that a large number of defects detected from the selected wafer have the featured values calculated using the generally employed method. The respective defects are classified into respective clusters using a known multilevel clustering method.

When two featured values are selected by the first featured value designation button 305 and the second featured value designation button 306, locations of the clusters are displayed with such codes as ◯ and Δ on the featured value space map 302.

Depending on the number of the cluster types, one or more defects to be instructed are automatically extracted through the predetermined process. The automatically extracted defect image 301 is sequentially displayed on the screen. FIG. 4 represents 10 defects (321 to 329) in total including one to four defects in each of four clusters. The automatic extraction through the predetermined process is defined as the process using coordinate on the featured value space of the defect. For example, defects are randomly extracted for each cluster as shown in the drawing. Besides the random extraction, other determination method may be employed for the defect extraction.

### (2) Initial Classification Class Instruction Means 102:

The correct classification class of displayed images of 10 defects are instructed in the classification class input column 310. The instructed content may be different from that of the cluster classified using the generally employed method.

### (3) Initial Classification Criterion and Classification Performance Calculation Means 103:

The classification criterion and classification performance are calculated using the instructed defect classification class and the featured value information.

The initial classification criterion is calculated using the neural network method as disclosed in Patent Document 3, for example. As the classification class of the instructed defect and the featured value are known, such information is input into the neural network which weights the featured value with a predetermined weight coefficient. Learning is conducted so that output information derived from the neural network is set to correspond to the defect classification class. In other words, in the learning, the obtained neural network output information and the defect classification class are compared. When an error value indicating disparity state exceeds the predetermined threshold value, the weight coefficient is corrected in accordance with the error value. Then the same defect data is input again to weight the featured value with the corrected weight coefficient. The aforementioned process is repeatedly performed until the error value becomes equal to or smaller than the threshold value.

According to the embodiment, in consideration of the distributed state of 10 defects instructed by the user as illustrated on the featured value space map 302, the featured value space map 302 is divided by the following three lines each as the classification criterion.
(a) Line for dividing the featured value space into substantially left and right regions with respect to substantially center of the space: 330

a1×f1+b1×f2+c1=0
(b) Line for dividing the featured value space into substantially upper and lower regions at a left section of the space: 331

a2×f1+b2×f2+c2=0
(c) Line for dividing the featured value space into substantially upper and lower regions at a right section of the space: 332

a3×f1+b3×f2+c3=0

All the defects on the featured value space map 302 will be determined based on the calculated classification criterion.

The classification class of each defect is determined in accordance with the following judgment conditions. The featured value space map 302 shown in FIG. 4 corresponds to a featured value space map 302a shown in FIG. 7.

If a1×f1i+b1×f2i+c1≧0̂a2×f1i+b2×f2i+c2≧0, the class corresponds to the foreign substance;

If a1×f1i+b1×f2i+c1≧0̂a2×f1i+b2×f2i+c2<0, the class corresponds to the open;

If a1×f1i+b1×f2i+c1<0̂a3×f1i+b3×f2i+c3≧0, the class corresponds to the grain; and

If a1×f1i+b1×f2i+c1<0̂a3×f1i+b3×f2i+c3<0, the class corresponds to the short-circuit.

According to the explanation as described above, three lines are used to define the classification criteria in accordance with the distribution state of 10 defects instructed by the user shown on the featured value space map 302. However, the known method does not have to be used for classifying the cluster so long as it is clear that use of the three lines is capable of defining the classification criterion in accordance with the defect distribution even if the clusters are not classified without conducting the cluster classification.

The other method using circle or semi-circle with a center may be employed in accordance with the distribution state.

Meanwhile, if five of 10 automatically extracted defects by the initial defect presenting means 101 coincide with the content instructed by the user, the classification performance may be calculated, that is, 5/10=50%, which will be displayed on the classification performance transition graph 313 indicating transition of the accuracy rate. The accuracy rate table 312 shows the defect class each automatically extracted and the defect class instructed by the user.

### (4) Defect Presenting Means 104

One or more defects to be instructed next are automatically extracted from those detected through inspection, and the image 301 of the automatically extracted defect is displayed on the screen likewise the initial presenting means 101. The automatic extraction of the defect to be instructed is conducted by extracting the defect around the boundary of the clusters, or automatically extracting the defect which is the closest to the gravity center of the adjacent cluster by applying the division optimized clustering method such as well-known k-means method. In this case, six defects 333 to 338 are automatically extracted as shown in FIG. 8, and displayed on the featured value space map 302a based on the calculated featured value.

### (5) Classification Class Instruction Means 105

The user instructs the classification class of the defect having its image displayed using the input column 310 like the case of the initial classification class instruction means 102.

### (6) Classification Criterion and Classification Performance Calculation Means 106

Like the initial classification criterion and classification performance calculation means 103, the classification criterion and the classification performance are calculated by executing the predetermined process using the classification class of the instructed defect and the featured value information. In this case, the classification criterion and classification performance are calculated with respect to total of 16 defects including 10 defects automatically extracted by the initial defect instruction means 101 and six defects automatically extracted by the defect presenting means 104 using the method represented by the initial classification class instruction means 102. The respective results are displayed on the featured value space map 302, the classification performance transition graph 313 and the accuracy rate table 312. The featured value space map is corrected likewise the initial classification class instruction means 102 as shown in FIG. 8.

### (7) Classification Performance Comparing Means 107

The classification performance calculated by the previous classification criterion and classification performance calculation means 106, and the classification performance calculated by the classification criterion and classification performance calculation means 106 earlier than the previous means, or the initial classification criterion and classification performance calculation means 103 are compared. Alternatively, the immediately previous classification performance calculated by the classification criterion and classification performance calculation means 106 and the classification performance calculated by the classification criterion and classification performance calculation means 106 one cycle before may also be compared. When the classification performance one cycle before is of the initial classification criterion and classification performance calculation means 103, it may be subjected to the comparison. As the transition of the classification performance may vary at a small interval, the comparison may be made after calculating the average movement with respect to the classification performance transition. If the calculated classification performance is higher than the one calculated one means before, it is determined that the classification performance is improved. If the calculated classification performance is lower or has hardly changed compared with the performance calculated one cycle before, it is determined that the classification performance has not been improved.

The classification performance transition graph 313 is used herein. The classification performance transition graph 313 plots the classification performance for each of the initial classification criterion and classification performance calculation means 103 and the classification criterion and classification performance calculation means 106 while defining X-axis as the number of operating the classification criterion and classification performance calculation means 106, and Y-axis as the classification performance.

When the classification performance is improved, the process returns to the defect presenting means 104 where one or more defects image from the defects, the classification classes of which have not been instructed is displayed on the screen. Thereafter, the process will be repeatedly executed as described above. If the classification performance is no longer improved, the process proceeds to (8) storage means 108 where the classification criterion obtained in the aforementioned process is stored as the set value. Thereafter, the inspection•classification will be executed using the set classification criterion.

FIG. 9 is formed by adding the sequence of normal inspection 402 to the aforementioned sequence of the classification criterion setting 401. The normal inspection sequence will be described hereinafter. In the normal inspection 402, an obtained classification criterion 415 is set in an inspection recipe, and obtains a defect image 417 by executing a defect determination 416 with respect to the semiconductor wafer. The obtained defect image 417 is subjected to image processing 418 to extract a featured value 419 of the defect. A defect classification 420 is executed using the extracted featured value 419 to obtain a classified result 421.

In a stage where the sequence of the criterion setting 401 is finished, the optimal defect classification result of the subject wafer may be obtained. Accordingly, the sequence of the criterion setting 401 may be set as the procedure of the normal inspection method.

In the aforementioned means and sequence, the multilevel clustering process is employed for automatically extracting the defect in the initial defect presenting means 101. However, any other method is applicable for each means, and accordingly, such method may be employed.

The embodiment provides method and device for inspection capable of improving the classification performance by a few appropriate defect instructions even in the state where a few DOIs exist in a large number of nuisances in the defect inspection.

The embodiment provides method and device for inspection capable of ensuring high classification performance while mitigating the burden of the user's defect instructions even in the state where a few DOIs exist in a large number of nuisances in the defect inspection.

The embodiment allows improvement of the classification performance with a few appropriate defect instructions by repeatedly instructing the classification class of the defect image automatically displayed on the screen by the user. This may ensure the high classification performance while mitigating the burden of the user's defect instructions.

According to the embodiment, the sequence of the criterion setting 401 is employed as the procedure of the normal inspection method. In this case, an updating classification criterion value is calculated. If the updating classification criterion value is largely different from the existing criterion value, it is considered that the process or the like has been changing. The means shown in FIG. 6 is employed to review the classification criterion value with new data so as to cope with the change in the process. If such change is relatively small, it is considered that the process undergoes the small change. In such a case, the normal inspection may be continuously conducted using the updating classification criterion value.

In the aforementioned description, the classification condition setting unit 500 is integrally formed with the main body of the device. However, the device may be structured to allow the external device to perform setting of the classification criterion value while having the units up to the general control unit 613 required for extracting the defect from the defect images built in the main body of the device. An optical inspection device may be employed as the device employed for the aforementioned case. An example of the optical inspection is illustrated in FIG. 10. The optical inspection device includes a stage 801 on which a sample 811 is placed for measuring a displacement coordinate of the sample 811, a stage drive unit 802 for driving the stage 801, a stage control unit 803 for controlling the stage drive unit 802 based on the displacement coordinate of the stage 801 measured therefrom, an oblique illumination optical system 804 for obliquely illuminating the sample 811 on the stage 801, a detection optical system 807 formed of a collecting lens 805 for collecting scattering light (diffraction light with low order other than zero order) from the surface of the sample 811, and a photoelectric conversion unit 806 which includes TDI and CCD sensor, an illumination control unit 808 for controlling the illuminance, light intensity and irradiating angle for illuminating the sample 811 by the oblique illumination optical system 804, a determination circuit (inspection algorithm circuit) 809 for aligning between the detection image signal from the photoelectric conversion unit 806 and the criterion image signal (reference image signal) obtained from adjacent chip or cell, comparing the aligned detection image signal and the criterion image signal to extract a differential image, detecting the image signal indicating the defect as a result of determination with respect to the extracted differential image using the predetermined threshold value so as to determine the defect based on the image signal indicating the detected defect, and a CPU 810 for executing various processes of the defect determined by the determination circuit 809 based on the stage coordinate system derived from the stage control unit 803.

The aforementioned optical inspection device is capable of providing the effect of the present invention when it is used together with the external device. Explanation of code
101: initial defect presenting means
102: initial classification class instruction means
103: initial classification criterion and classification performance calculation means
104: defect presenting means
105: classification class instruction means
106: classification criterion and classification performance calculation means
107: classification performance comparing means
108: storage means
201: classification criterion set button
202: wafer selection tab
203: list
204: Atype BBstep CCClot DDDDwafer
205: open button
206: instruction tab
301: defect image
302: featured value space map
303: plot of detected defects
304: plot of automatically extracted defects
305: first featured value designation button
306: second featured value designation button
307: featured value display unit
308: X-axis
309: Y-axis
310: input column
311: classification class selection menu
312: classification performance
401: criterion setting
402: normal inspection
403: determine defect
404: defect image
405: process image
406: featured vale
407: set classification criterion
415: classification criterion
416: determine defect
417: defect image
418: process image
419: featured value
420: classify defect
421: classification result
500: classification condition setting unit
501: defect determination unit
502: image processing unit
503: defect classification unit
506: data storage unit
507: user interface unit
508: classification criterion setting server
600: SEM type semiconductor wafer inspection device
601: electron source
602: electron beam
603: deflector
604: objective lens
605: semiconductor wafer
606: stage
607: secondary electron
608: detector
609: A/D converter
610: image processing circuit
611: detection condition setting unit
612: determination condition setting unit
613: general control unit
801: stage
802: stage drive unit
803: stage control unit
804: oblique illumination optical system
805: collection lens
806: photoelectric converter
807: detection optical system
808: illumination control unit
809: determination circuit
810: CPU
811: sample

1. An inspection method comprising: a defect extraction step of extracting one or more defects from plural defects detected by imaging a sample; a defect image display step of displaying an image of the extracted defect; a defect classification class input step of inputting a classification class of the displayed defect; a classification criterion calculation step of calculating a classification criterion from image information and classification class of the defects which have been extracted; a classification performance determination step of determining a performance of the defect classification based on the classification criterion; and an inspection step of inspecting unknown defects based on the classification criterion calculated in the classification criterion calculation step.

2. The inspection method according to claim 1, further comprising a classification criterion cluster classification step of classifying the plural defects into clusters based on the classification criterion formed in the classification criterion calculation step.

3. The inspection method according to claim 2, wherein the classification performance determination step determines a performance based on right or wrong of the defect classification class classified in the classification criterion cluster classification step to the defect classification class input by the defect classification class input step.

4. The inspection method according to claim 2, further comprising a step of distinguishing the plural defects classified in the classification criterion cluster classification step on a featured value space map for each classification class so as to be displayed.

5. The inspection method according to claim 1, further comprising a cluster classification step of classifying clusters of the plural defects detected by imaging the sample.

6. An inspection method comprising: a step of extracting one or more first defects from a group of plural defects detected by imaging a sample, displaying an image of the first defect, and inputting a classification class of the first defect; a step of calculating a first classification criterion of the group of defects based on the input classification class and a featured value of the first defect; a step of extracting one or more second defects from a group of defects, which is different from the group of plural defects based on the calculated classification criterion, and inspecting the second defect;
a step of displaying an image of the second defect and inputting a classification class of the second defect; a step of calculating the classification criterion of the different group of defects based on the input classification class and a featured value of the second defect; and a comparing step of comparing the first classification criterion with the second classification criterion.

7. An inspection device comprising: defect extraction means for extracting one or more defects from plural defects detected by imaging a sample; defect image display means for displaying an image of the extracted defect; defect classification class input means for inputting a classification class of the displayed defect; classification criterion calculation means for calculating a classification criterion from image information and classification class of the defects which have been extracted; classification performance determination means for determining a performance of the defect classification based on the classification criterion; and inspection means for inspecting an unknown defect based on the classification criterion calculated by the classification criterion calculation means.

8. The inspection device according to claim 7, further comprising classification criterion cluster classification means for classifying the plural defects into clusters based on the classification criterion formed by the classification criterion calculation means.

9. The inspection device according to claim 8, wherein the classification performance determination means determines a performance based on right or wrong of the defect classification class classified by the classification criterion cluster classification means to the defect classification class input by the defect classification class input means.

10. The inspection device according to claim 7, further comprising means for displaying a distribution of the plural defects detected by imaging the sample as a featured value space map.

11. An inspection device comprising: means for extracting one or more first defects from a group of plural defects detected by imaging a sample, displaying an image of the first defect, and inputting a classification class of the first defect; means for calculating a first classification criterion of the group of defects based on the input classification class and a featured value of the first defect; means for extracting one or more second defects from a group of defects, which is different from the group of plural defects based on the calculated classification criterion, and inspecting the second defect; means for displaying an image of the second defect and inputting a classification class of the second defect; means for calculating the classification criterion of the different group of the defects based on the input classification class and a featured value of the second defect; and comparing means for comparing the first classification criterion with the second classification criterion.

12. The inspection device according to claim 11, further comprising determination means for determining with respect to a change in a sample forming process based on a result of the comparing means.
